(19) United States
(12) Patent Application Publication
(10) Pub. No.: US 2013/0014882 A1
(43) Pub. Date: Jan. 17, 2013

(54) METHOD FOR PRODUCING COATING MATERIAL

(71) Applicant: Johannes Schmid, Starzach (DE)

(72) Inventor: Johannes Schmid, Starzach (DE)

(73) Assignee: HOMAG Holzbearbeitungssysteme AG, Schopfloch (DE)

(21) Appl. No.: 13/500,087

(22) PCT Filed: Mar. 23, 2011
(86) PCT No.: PCT/EP11/54444

§ 371 Date: Apr. 18, 2012

(30) Foreign Application Priority Data
Apr. 9, 2010 (EP) 10159477.8

(51) Int. Cl. B05D 5/10; B32B 37/12

(52) U.S. Cl. 156/60; 427/207.1; 427/208.2

(57) ABSTRACT

The invention relates to a method for producing coating material (1) for workpieces, comprising the steps of: providing a web-shaped or strip-shaped base material (2), feeding the base material into a coating system (6), pre-treating at least one surface of the base material (2), and applying a functional layer (5) to the pre-treated surface of the base material (2), wherein the functional layer (5) can be activated by an energy source (7), such that said layer develops adhesive properties.

### TECHNICAL FIELD

The present invention is in regard to a method for producing coating material for workpieces, particularly plate-shaped workpieces or three-dimensional workpieces consisting at least in sections of wood, wood-based materials, plastic or the like.

In this application, coating is to be understood to be a permanent coating material such as a web-shaped or strip-shaped narrow surface coating of plastic or real wood veneer (with limited elastic deformability).

### PRIOR ART

Plate-shaped workpieces which have a rough surface structure on the cut narrow surfaces of the workpieces are processed in the furniture industry in particular. Various methods have been established in the prior art for coating these narrow surfaces of the workpieces. Applying a web-shaped or strip-shaped coating material to the narrow surfaces of the workpieces, such as by gluing, is widespread. The known methods have the same problems, i.e. that the coating is supposed to be applied with minimal effort, a strong bond between the coating and the base material is supposed to be achieved and an adhesion between the base material and the coating material should be as imperceptible as possible.

It has been shown that to produce the base material, the coating material and the adhesion between the base material and a workpiece respectively, very specific know-how is required. The producer of the base material often has problems providing the base material with a functional layer for adhesion which meets the current stringent requirements for the strength and appearance of the adhesion. In particular, one problem that arises is that the color of the functional layer for adhesion must match that of the base material of the coating material exactly and also that of the workpiece so that it will not be visible at a later point in time. With the wide variety of products available today, the problem is to produce functional layers for adhesion with minimal effort in a specified color.

### DESCRIPTION OF THE INVENTION

Thus, the object of the present invention is to provide a method for producing coating material for coating workpieces in which the above-mentioned disadvantages are removed. In particular, the method according to the invention should facilitate the provision of an existing base material of a coating material with a functional layer for the adhesion to a workpiece, which can be activated for the adhesion of the coating material to a workpiece.

According to the invention, this object is solved by a method having the features of claim 1. Advantageous embodiments and improvements of the invention can be found in the subclaims.

A method according to the invention for producing coating material for workpieces comprises the following method steps: providing a web-shaped or strip-shaped base material, feeding the base material into a coating station, pre-treating at least one surface of the base material and applying a functional layer to the pre-treated surface of the base material, the functional layer being able to be activated by an energy source such that it develops adhesive properties. The method according to the invention facilitates the provision of an available web-shaped or strip-shaped base material with a functional layer that can be activated when supplied with energy such that it develops adhesive properties. The method steps for producing the base material, for applying a functional layer on the base material, which can be activated such that it develops adhesive properties, and finally for applying the coating material onto a workpiece by means of the functional layer can be decoupled from one another with respect to time with the present invention. Thus, an interim storage both of the base material and of the base material with the functional layer applied is possible. The coating of the workpieces can therefore become more flexible. The method step of pre-treating a surface of the base material enables the properties of the base material to be adapted for the application of the functional layer. In this way, the properties of the base material provided can be reacted to in a very flexible manner. For example, the properties of the base material can be adapted for the application of the functional layer. Adapting the base material to the workpiece to be coated is also possible.

The pre-treatment preferably comprises a treatment selected from the group consisting of heating, pre-cleaning, degreasing, improving the adhesive and wetting properties and reducing the electrostatic charge. Preferably, depending on the material and/or the surface condition of the base material, one or more of the above-mentioned treatment alternatives is used. Thus, the properties of all of the various base materials can be taken into account. Due to the pre-treatment, a specific functional layer can be used in combination with very different base materials. It is also possible to facilitate the application of a functional layer with particular properties by means of pre-treatment in accordance with the desired product requirements. As a result, there is greater freedom in the choice of possible functional layers for a particular base material, depending on the requirements that the later workpiece is supposed to have. Moreover, owing to the pre-treatment the base material can be adapted to the manufacturing possibilities available in a manufacturing plant, which later applies the coating material to the workpiece to be coated.

Particularly preferably, the functional layer is applied using a roll or preferably using a nozzle or a matrix. The application preferably depends on the consistency of the functional layer and the condition of the pre-treated base material. The application of the functional layer by means of a nozzle enables a particularly even distribution of the functional layer. If a functional layer having a greater thickness is applied, the functional layer is preferably applied using a roll.

According to a preferred embodiment of the present invention, additives are added to the functional layer prior to application. Preferably, pigments are used, and particularly preferably additives are used to increase the energy absorption capacity of the functional layer. By adding pigments, the functional layer can be adapted in terms of its coloring to the base material or to the workpiece to be coated with the coating material. The addition of additives to increase the energy absorption capacity of the functional layer enables the activation of the adhesive properties of the functional layer by means of the energy source. For instance, an increased energy absorption capacity of the functional layer enables an increase in the feed rate when applying the functional layer to a workpiece, without having to increase the energy source for supplying energy to the cable. If, for example, a laser is used to activate the functional layer in a continuous throughfeed, the feed rate can be increased by increasing the energy absorption capacity of the functional layer without the need to increase the efficiency of the laser. If one starts from an unchanged energy source, higher feed rates for the application of the coating material to the workpiece can be realized owing merely to the addition of additives for increasing the energy absorption capacity of the functional layer. It is also preferable that the absorption spectrum of the functional layer be adapted to the light emission spectrum when using a laser, in order to achieve an optimal energy yield. In this way, the energy balance of the activation of the functional layer and therefore the energy balance of the application of the coating material onto a workpiece as a whole can be improved.

The energy source for supplying energy to the functional layer is preferably selected from the group consisting of laser, hot-air source, infrared source, ultrasound source, magnetic field source, microwave source, plasma source and gassing source. The laser allows an occasional energy supply to the functional layer that can be accurately dosed. Moreover, the laser enables a particularly quick focus of the energy on a particular area of the coating material. The energy can also be provided particularly quickly using the laser, which facilitates particularly good process dynamics. The use of a plasma source as an energy source facilitates the supply of energy with a great penetration depth in the coating material. Thus, the functional layer of the coating material can be activated by means of an energy supply also with thicker coating materials and once the coating material has been applied to the workpiece. The plasma source allows a particularly homogenous depth distribution of the energy supplied to the coating material.

According to a preferred embodiment of the method according to the invention, the coating material is joined after the application of the functional layer to a workpiece, or particularly preferably is rolled out after at least a partial cooling of the functional layer. The joining of the functional layer onto a workpiece after the application of the functional layer has the advantage that the coating material can immediately be further processed and an interim storage with the corresponding operation procedures is not required. However, the method according to the invention also allows the rolling out of the coating material after the application of the functional layer after at least a partial cooling of the functional layer and then, for example, the interim storage or the transportation. With this variant of the method according to the invention, the establishment of the coating material that can be activated from the application of the coating material onto a workpiece can be coupled temporally and spatially. This allows greater flexibility when coating workpieces. It is possible, for example, to have the production of the coating material and the actual coating of workpieces carried out by separate service providers. In this way, the production costs can be reduced and the product quality can be improved.

According to a preferred embodiment of the present invention, the method is carried out in the throughfeed of continuously moving or intermittently moving base materials. With this variant of the method, a particularly high material throughfeed can be realized. Moreover, the energy sources used to activate the functional layer can, in principle, be continuously operated, which decreases energy consumption and reduces the risk of breakdown.

### BRIEF DESCRIPTION OF THE DRAWINGS

The Figures show:

FIG. 1: a schematic cross-section view of the sequence of actions of the method according to the invention for producing coating material according to a first embodiment example; and

FIG. 2: a schematic cross-section view of the sequence of actions of the method according to the invention for producing coating material according to a second embodiment example.

### DETAILED DESCRIPTION OF THE PREFERRED EMBODIMENTS

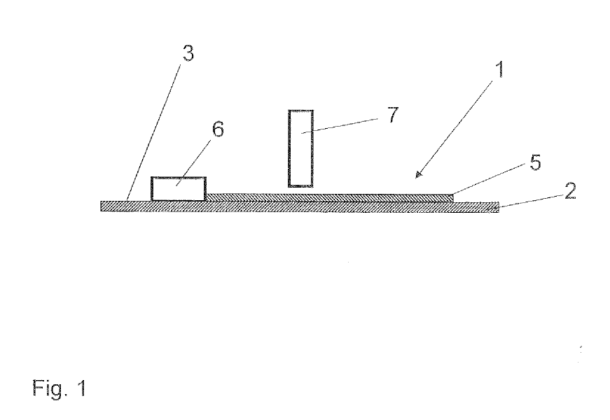

FIG. 1 shows a schematic cross-section view of the sequence of actions of the method according to the invention for producing coating material 1 according to a first embodiment example. According to this embodiment example, a web-shaped base material 2 is provided, which is hatched in the illustration below. The base material 2 is fed into a coating station 6 represented as a rectangle. A surface 3 of the base material 2, the upper side in the drawing, is pre-treated, in which it is cleaned. Subsequently, a functional layer 5, which is also hatched in the drawing, is applied to the base material 2 such that the coating material 1 is formed. By means of an energy source 7, which is shown in the drawing as a rectangle, energy can be supplied to the coating material, particularly to the functional layer 5, such that the functional layer develops adhesive properties. The energy source 7 is shown here to improve understanding and is at first not required in the method according to the invention according to this embodiment example.

The method according to the invention allows coating material 1 to be produced, which is provided based on a base material 2 with the intermediate step of a pre-treatment using a functional layer 5 that can be activated with energy. The intermediate step of pre-treatment enables the functional layer 5 to be applied to base material 2 of varying conditions. Moreover, owing to the pre-treatment functional layers 5 can be applied to the base material 2 which could not have been used without pre-treatment. The method according to the invention therefore facilitates production of coating material 1 for workpieces in a particularly flexible manner.

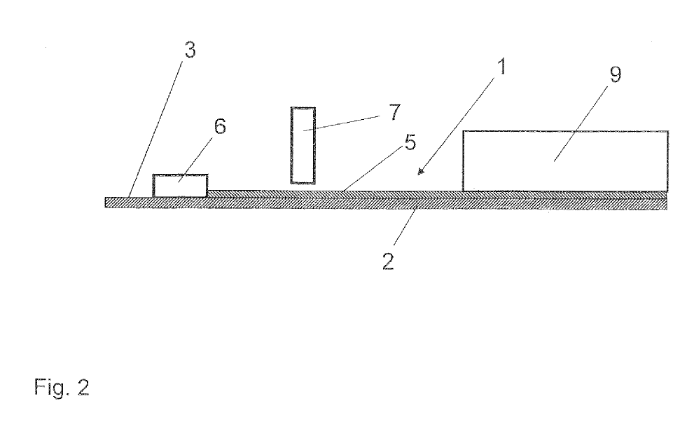

FIG. 2 shows a schematic cross-section view of the sequence of actions of the method according to the invention for producing coating material according to a second embodiment example. The method shown in FIG. 2 is based on the method according to the embodiment example of FIG. 1. However, joining the coating material 1 to a workpiece 9 is also shown here. An activation of the functional layer 5 by the energy source 7 takes place prior to the joining of the coating material 1 to the workpiece 9. Preferably, the coating material 1 is pressed against the workpiece 9.

### LIST OF REFERENCE NUMBERS

1 Coating material
2 Base material
3 Surface of the base material
5 Functional layer
6 Coating station
7 Energy source
9 Workpiece

1. A Method for producing coating material for workpieces having the following steps:
providing a web-shaped or strip-shaped base material,
feeding the base material into a coating station,
pre-treating at least one surface of the base material, and
applying a functional layer onto the pre-treated surface of the base material, wherein the functional layer can be activated by an energy source such that it develops adhesive properties.

2. The method according to claim 1, wherein the pre-treatment comprises a treatment selected from the group consisting of heating, pre-cleaning, degreasing, improving the adhesive and wetting properties and reducing the electrostatic charge.

3. The method according to claim 1, wherein the type of pre-treatment is selectively chosen depending on the material and/or the surface condition of the base material.

4. The method according to claim 1, wherein the functional layer is applied by means of a roll and/or a nozzle and/or a matrix.

5. The method according claim 1, wherein the functional layer to be applied is prepared using an extruder and/or a melting pot.

6. The method according to claim 1, wherein additives are added to the functional layer prior to application, particularly pigments and/or additives for increasing the energy absorption capacity of the functional layer.

7. The method according to claim 1, wherein the base material is selected from the group consisting of plastic, particularly thermoplastic material, veneer, paper, cardboard, metal and combinations thereof.

8. The method according to claim 1, wherein at least one energy source is selected from the group consisting of laser, hot-air source, infrared source, ultrasound source, magnetic field source, microwave source, plasma source and gassing source.

9. The method according to claim 1, wherein the coating material is joined to a workpiece after the application of the functional layer or is rolled out after at least a partial cooling of the functional layer.

10. The method according to claim 1, wherein the method is carried out in the throughfeed with the base material moving continuously or intermittently.
